(19) United States
(12) Patent Application Publication
(10) Pub. No.: US 2017/0207669 A1
(43) Pub. Date: Jul. 20, 2017

(54) Motor And Outer Magnetic Core And Inner Magnetic Core Thereof

(71) Applicant: Johnson Electric S.A., Murten (CH)

(72) Inventors: Tao ZHANG, Shenzhen (CN); Jie CHAI, Shenzhen (CN); San Yuan XIAO, Hong Kong (CN)

(21) Appl. No.: 15/407,649

(22) Filed: Jan. 17, 2017

(30) Foreign Application Priority Data
Jan. 14, 2016 (CN) 2016 1002 5031.1

(51) Int. Cl. H02K 1/14; H02K 7/14; H02K 9/06; H02K 1/27

(52) U.S. Cl. CPC H02K 1/146; H02K 1/2706; H02K 7/14; H02K 9/06; H02K 2213/03

(57) ABSTRACT

A motor including a motor outer magnetic core and a motor inner magnetic core. The motor outer magnetic core includes an annular yoke and a plurality of teeth. Each tooth includes a tooth body and a pole shoe. The pole shoes of the plurality of teeth cooperatively define a discontinuous inner ring. The motor inner magnetic core is surrounded by the inner ring. The motor inner magnetic core includes a central portion and a plurality of pole portions surrounding an outer side of the central portion. Each of the pole portions and the central portion define a gap therebetween for receiving a permanent magnet. First connecting portions are connected between adjacent ones of the pole portions. Second connecting portions are connected between the first connecting portions and the central portion.

### CROSS REFERENCE TO RELATED APPLICATIONS

This non-provisional patent application claims priority under 35 U.S.C. §119(a) from Patent Application No.201610025031.1 filed in The People's Republic of China on Jan. 14, 2016.

### FIELD OF THE INVENTION

This present disclosure relates to motor field, and in particular to a motor and an outer magnetic core and an inner magnetic core of the motor.

### BACKGROUND OF THE INVENTION

A stator and/or a rotor of a motor typically include a magnetic core made of a soft magnetic material for conducting and intensifying a magnetic field. The construction of the magnetic core is related to power characteristics of the motor. Motor manufacturers have been working to optimize the magnetic core to obtain better performance parameters such as motor output power.

### SUMMARY OF THE INVENTION

Thus there is a desire for motor with improved output power.

Accordingly, a motor is provided which includes a motor outer magnetic core and a motor inner magnetic core that are rotatable relative to each other. The motor outer magnetic core includes an annular yoke; a plurality of teeth extending inwardly from the yoke, each of the teeth comprising a tooth body and a pole shoe extending from an end of the tooth body toward two sides of the tooth body, the pole shoes of the plurality of teeth cooperatively defining a discontinuous inner ring, a ratio of an diameter ID of the inner ring to an outer diameter OD of the yoke being in the range of 0.45 to 0.65. The motor inner magnetic core includes a central portion; a plurality of pole portions surrounding an outer side of the central portion, adjacent ones of the pole portions being spaced from each other, each of the pole portions and the central portion defining a gap therebetween for receiving a permanent magnet; a plurality of first connecting portions each connected between two corresponding ones of the pole portions; and a plurality of second connecting portions each connected between a corresponding one of the first connecting portions and the central portion.

Preferably, the motor outer magnetic core is a motor stator, and the motor inner magnetic core is a motor rotor.

Preferably, the motor further comprises a first end cap, a second end cap, and a connecting member. The first end cap and the second end cap are respectively mounted to two ends of the motor outer magnetic core. The second end cap comprises an axial hollow post extending into a winding slot formed between the teeth of the motor outer magnetic core; the connecting member passes through a through hole of the hollow post to fasten the first end cap and the second end cap to the two ends of the motor outer magnetic core.

Preferably, a rotary shaft of the motor is mounted with an airflow generating device, and the airflow generating device generates airflow during operation of the motor. The airflow flows through an air gap between the motor outer magnetic core and the motor inner magnetic core.

Preferably, outer surfaces of the plurality of pole portions are located on a common cylindrical surface, and outer surfaces of the first connecting portions are located outside of the cylindrical surface.

Preferably, outer surfaces of the plurality of pole portions are located on a common cylindrical surface, and an electric angle corresponding to a central angle θ of each of the pole portions is in the range of 110 to 150 degrees.

Preferably, the electric angle corresponding to the central angle θ of each of the pole portions is in the range of 120 to 135 degrees.

Preferably, a length D1 of the first connecting portions is three to six times of a length D2 of the second connecting portions.

Preferably, the length D1 of the first connecting portions is four to five times of the length D2 of the second connecting portions.

Preferably, the first connecting portions and the second connecting portions are each strip-shaped, and each of the second connecting portions is connected to a middle of a corresponding one of the first connecting portions to thereby form a T-shape.

Preferably, the diameter ID of the inner ring is 0.5 to 0.58 times of the outer diameter of the yoke.

Preferably, a radial width W2 of the yoke is 0.45 to 0.65 times of a circumferential width W1 of the tooth body.

The motor according to the preferred embodiments of the present invention has greater output power, which makes the motor have greater power density.

Embodiments of the present invention will be described below with reference to the accompanying drawings.

### BRIEF DESCRIPTION OF THE DRAWINGS

FIG. 1 illustrates a motor according to one embodiment of the present invention.

FIG. 2 is a longitudinal cross-sectional view of the motor of FIG. 1.

FIG. 3 is a transverse cross-sectional view of the motor of FIG. 1.

FIG. 4 illustrates a motor inner magnetic core utilized by the motor of FIG. 1.

FIG. 5 illustrates a magnetic path distribution of the motor of FIG. 1.

FIG. 6 illustrates a curve of the magnetic flux density in a gap between the stator and rotor under the magnetic path distribution of FIG. 1.

FIG. 7 illustrates an end cap utilized by the motor of FIG. 1.

### DETAILED DESCRIPTION OF THE PREFERRED EMBODIMENTS

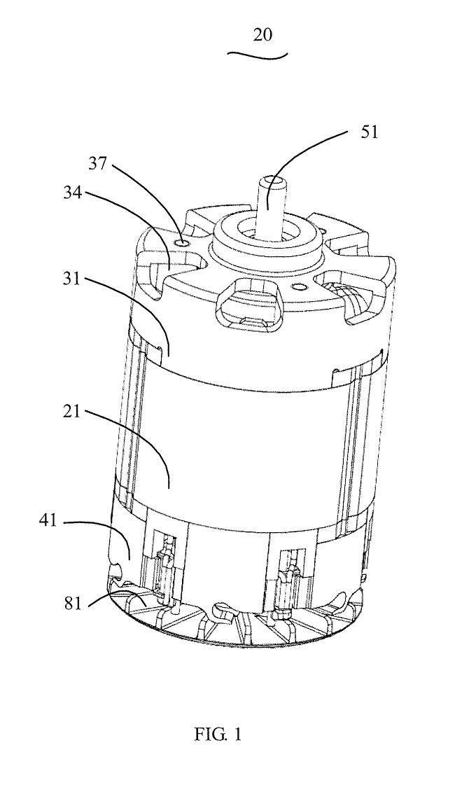

Referring to FIG. 1 to FIG. 3, a motor 20 in accordance with a preferred embodiment of the present invention includes a stator and a rotor. The stator includes a motor outer magnetic core 21, and a first end cap 31 and a second end cap 41 mounted to two axial ends of the motor outer magnetic core 21. The rotor includes a rotary shaft 51 and a motor inner magnetic core 53 fixed to the rotary shaft 51. Bearing seats 33, 43 are disposed at centers of the first end cap 31 and second end cap 41, respectively. Two ends of the rotary shaft 51 are mounted to the bearing seats 33, 43 via corresponding bearings, respectively, such that the rotor is capable of rotation relative to the stator. In an alternative embodiment, the motor outer magnetic core 21 acts as the rotor, and the motor inner magnetic core 53 acts as the stator.

The motor outer magnetic core 21 includes an annular yoke 22, and a plurality of teeth 23 extending inwardly from the yoke 22. Each of the teeth 23 includes a tooth body and a pole shoe 24 extending from a distal end toward two sides of the tooth body. A winding slot is formed between each two adjacent teeth 23. Stator windings 25 are wound around their respective tooth bodies in a concentrated winding manner and are received in their respective winding slots. The pole shoes 24 of the plurality of the teeth 23 cooperatively define a discontinuous inner ring. A ratio of a diameter ID of the inner ring to an outer diameter OD of the yoke 22 is in the range of 0.45 to 0.65. More preferably, the diameter ID of the inner ring is 0.5 to 0.58 times of the outer diameter OD of the yoke 22.

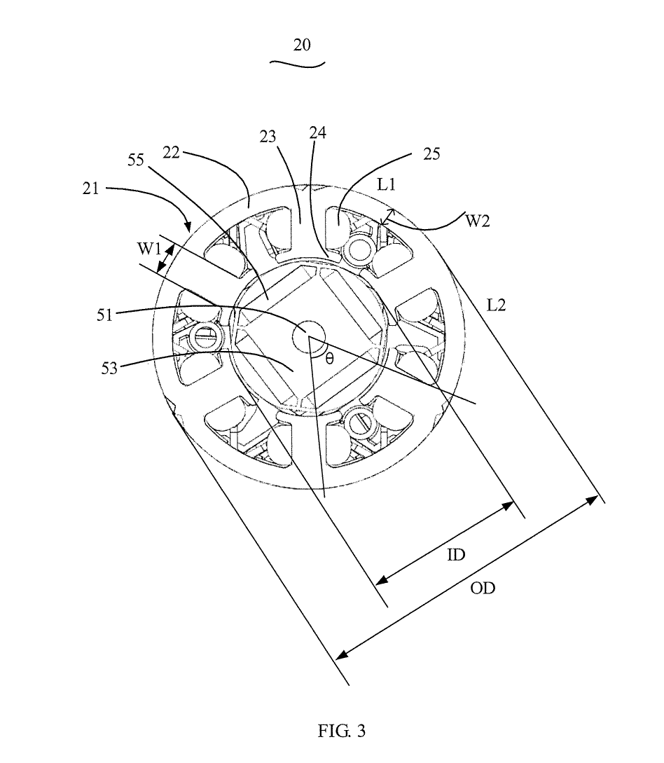

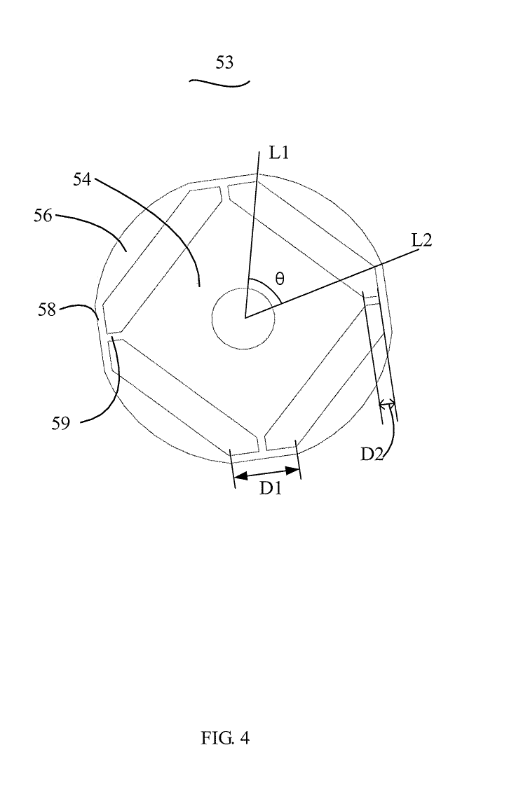

Referring to FIG. 3 and FIG. 4, the motor inner magnetic core 53 is surrounded by the motor outer magnetic core 21 and includes a central portion 54, a plurality of pole portions 56 surrounding an outer side of the central portion 54, a plurality of first connecting portions 58, and a plurality of second portions 59. Adjacent pole portions 56 are spaced from each other. A gap is formed between each pole portion 56 and the central portion 54, for receiving a permanent magnet 55. Each first connecting portion 58 is connected between two pole portions 56, and each second connecting portion 59 is connected between one corresponding first connecting portion 58 and the central portion 54. The first connecting portion 58 and the second connecting portion 59 are both strip-shaped, and each second connecting portion 59 is connected to a middle of the corresponding first connecting portion 58 to thereby form a T-shape.

Outer surfaces of the plurality of pole portions 56 are commonly located on a cylindrical surface, and outer surfaces of the first connecting portions 58 are located outside of the cylindrical surface.

In this embodiment, the permanent magnet 55 is plate-shaped and mounted in the gap between each pole portion 56 and the central portion 54. Each pole portion 56 corresponds to one permanent magnet 55 mounted in the gap. Each permanent magnet 55 is polarized along a radial direction of the motor inner magnetic core 53 to form N-pole or S-pole on the outer surface thereof, and the N-poles and S-poles are alternatively formed by the pole portions 56 of the motor inner magnetic core 53. A central angle θ of each pole portion 56 corresponds to an electric angle of 110 to 150 degrees. For a motor in which the motor inner magnetic core 53 has four magnetic poles, the electric angle is twice of its corresponding mechanical angle. That is, the mechanical angle corresponding to the central angle θ is in the range of 55 to 75 degrees.

Preferably, the electric angle corresponding to the central angle θ of each pole portion 56 is in the range of 120 to 135 degrees.

In this embodiment, a length D1 of the first connecting portion 58 is three to six times of a length D2 of the second connecting portion 59. Preferably, the length D1 of the first connecting portion 58 is four to five times of the length D2 of the second connecting portion 59.

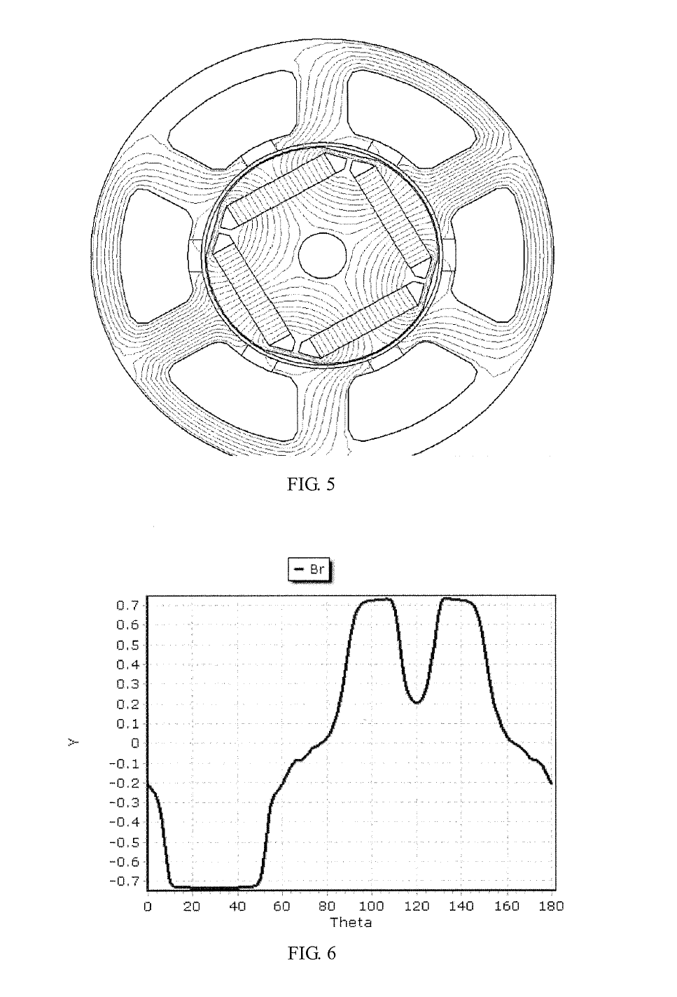

Referring to FIG. 5 and FIG. 6, the electric angle corresponding to the central angle θ of each pole portion 56 is 125 degrees, the amount of magnetic leakage is reduced. FIG. 6 illustrates magnetic flux density distribution in the gap between the motor outer magnetic core 21 and the motor inner magnetic core 53 corresponding to a pair of magnetic poles (i.e. the electric angle is 360 degrees, which corresponds to a mechanical angle of 180 degrees in this embodiment). As can be seen, a majority of the magnetic flux pass through the stator teeth, with only a few part of the magnetic flux leaks through the pole shoes.

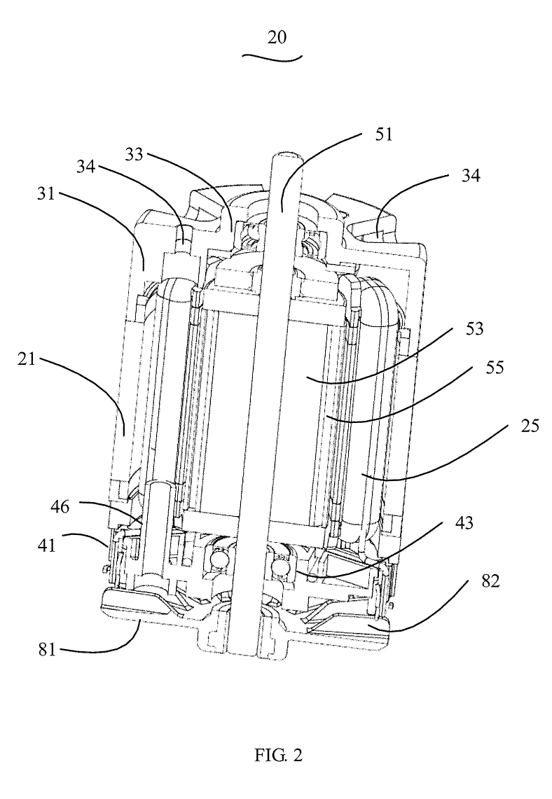

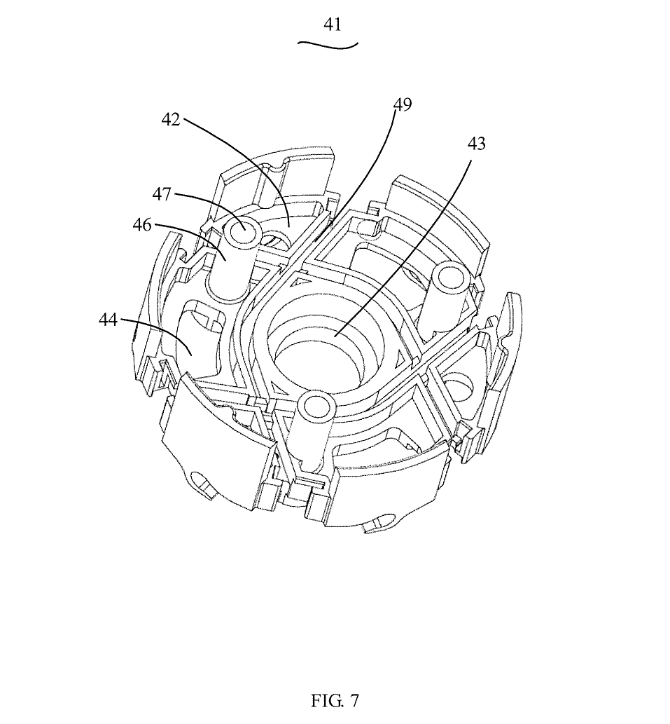

Referring to FIG. 7, the second end cap 41 includes a main portion 42, the bearing seat 43 formed at a center of the main portion 42, and a plurality of hollow posts 46 formed on the main portion 42. As shown in FIG. 7 and FIG. 2, each hollow post 46 extends into the winding slot of the motor outer magnetic core 21, such that the second end cover 41 can be positioned during assembly. In addition, the hollow post 46 has a through hole 47, a connecting member such as a screw can pass through the through hole 47 and a through hole 37 (FIG. 2) of the first end cap 31 to thereby retain the first end cap 31 and the second end cap 41 to the two axial ends of the motor outer magnetic core 21 in the axial direction.

In addition, referring to FIG. 2, one end of the rotary shaft 51 is further mounted with an airflow generating device 81. The airflow generating device 81 includes a plurality of blades 82. Once the motor operates, the rotary shaft 51 drives the airflow generating device 81 to rotate, such that the blades 82 generate airflow. This airflow may flow through the motor along the axial direction of the motor. Specifically, as shown in FIG. 7, the second end cap 41 includes a plurality of air inlets 44 and, after air enters an interior of the motor via the air inlets 44, the air can flow to the first end cap 31 along the winding slots of the motor outer magnetic core 21 and the gap between the motor outer magnetic core 21 and the motor inner magnetic core 53, and can be discharged from air outlets 34 (FIG. 1) of the first end cap 31, which can therefore help dissipating heat of the motor.

Although the invention is described with reference to one or more embodiments, the above description of the embodiments is used only to enable people skilled in the art to practice or use the invention. It should be appreciated by those skilled in the art that various modifications are possible without departing from the spirit or scope of the present invention. The embodiments illustrated herein should not be interpreted as limits to the present invention, and the scope of the invention is to be determined by reference to the claims that follow.

1. A motor comprising:
a motor outer magnetic core comprising:
an annular yoke; and
a plurality of teeth extending inwardly from the yoke, each of the teeth comprising a tooth body and a pole shoe extending from an end of the tooth body toward two sides of the tooth body, the pole shoes of the plurality of teeth cooperatively defining a discontinuous inner ring, a ratio of an diameter of the inner ring to an outer diameter of the yoke being in the range of 0.45 to 0.65; and
a motor inner magnetic core rotatable relative to the motor outer magnetic core, the motor inner magnetic core comprising:
a central portion;
a plurality of pole portions surrounding an outer side of the central portion, adjacent ones of the pole portions being spaced from each other, each of the pole portions and the central portion defining a gap therebetween for receiving a permanent magnet;
a plurality of first connecting portions each connected between two corresponding ones of the pole portions; and
a plurality of second connecting portions each connected between a corresponding one of the first connecting portions and the central portion.

2. The motor of claim 1, wherein the motor outer magnetic core is a motor stator, and the motor inner magnetic core is a motor rotor.

3. The motor of claim 1, wherein the motor further comprises a first end cap, a second end cap, and a connecting member, the first end cap and the second end cap are respectively mounted to two ends of the motor outer magnetic core; the second end cap comprises an axial hollow post extending into a winding slot formed between the teeth of the motor outer magnetic core; the connecting member passes through a through hole of the hollow post to fasten the first end cap and the second end cap to the two ends of the motor outer magnetic core.

4. The motor of claim 1, wherein a rotary shaft of the motor is mounted with an airflow generating device, and the airflow generating device generates airflow during operation of the motor, the airflow flowing through an air gap between the motor outer magnetic core and the motor inner magnetic core.

5. A motor inner magnetic core comprising:
a central portion;
a plurality of pole portions surrounding the central portion, adjacent ones of the pole portions being spaced from each other, each of the pole portions and the central portion defining a gap therebetween for receiving a permanent magnet;
a plurality of first connecting portions each connected between two corresponding ones of the pole portions; and
a plurality of second connecting portions each connected between a corresponding one of the first connecting portions and the central portion.

6. The motor inner magnetic core of claim 5, wherein outer surfaces of the plurality of pole portions are located on a common cylindrical surface, and outer surfaces of the first connecting portions are located outside of the cylindrical surface.

7. The motor inner magnetic core of claim 5, wherein outer surfaces of the plurality of pole portions are located on a common cylindrical surface, and an electric angle corresponding to a central angle of each of the pole portions is in the range of 110 to 150 degrees.

8. The motor inner magnetic core of claim 7, wherein the electric angle corresponding to the central angle of each of the pole portions is in the range of 120 to 135 degrees.

9. The motor inner magnetic core of claim 5, wherein a length of the first connecting portions is three to six times of a length of the second connecting portions.

10. The motor inner magnetic core of claim 9, wherein the length of the first connecting portions is four to five times of the length of the second connecting portions.

11. The motor inner magnetic core of claim 5, wherein the first connecting portions and the second connecting portions are each strip-shaped, and each of the second connecting portions is connected to a middle of a corresponding one of the first connecting portions to thereby form a T-shape.

12. A motor outer magnetic core comprising:
an annular yoke; and
a plurality of teeth extending inwardly from the yoke, each of the teeth comprising a tooth body and a pole shoe extending from an end of the tooth body toward two sides of the tooth body, the pole shoes of the plurality of teeth cooperatively defining a discontinuous inner ring, an diameter of the inner ring being 0.45 to 0.65 times of an outer diameter of the yoke.

13. The motor outer magnetic core of claim 12, wherein the diameter of the inner ring is 0.5 to 0.58 times of the outer diameter of the yoke.

14. The motor outer magnetic core of claim 12, wherein a radial width of the yoke (22) is 0.45 to 0.65 times of a circumferential width of the tooth body.
